(19) United States
(12) Patent Application Publication
(10) Pub. No.: US 2016/0002791 A1
(43) Pub. Date: Jan. 7, 2016

(54) METHOD FOR PRODUCING AN ELECTRICALLY CONDUCTIVE STRUCTURE ON A NON-CONDUCTIVE SUBSTRATE MATERIAL, AND ADDITIVE AND SUBSTRATE MATERIAL INTENDED THEREFOR

(71) Applicant: LPKF LASER & ELECTRONICS AG, Garbsen (DE)

(72) Inventors: Robin Alexander KRÜGER, Hannover (DE); Bernd RÖSENER, Porta Westfalica (DE); Wolfgang JOHN, Neustadt am Ruebenberge (DE); Arne SCHNOOR, Hannover (DE); Roman OSTHOLT, Isernhagen (DE)

(21) Appl. No.: 14/655,056

(22) PCT Filed: Dec. 6, 2013
(86) PCT No.: PCT/DE2013/100412

§ 371 Date: Jun. 24, 2015

(30) Foreign Application Priority Data
Jan. 2, 2013 (DE) 10 2013 100 016.9

(51) Int. Cl. C23C 18/18; C23C 18/28; H01B 1/02; C23C 18/20

(52) U.S. Cl. CPC C23C 18/1868; C23C 18/204; C23C 18/28; H01B 1/02

(57) ABSTRACT

A method for producing an electrically conductive structure, e.g., a conducting track, on a non-conductive substrate material, having an additive (1) having at least one metal compound. The substrate material may be irradiated using a laser to selectively activate the metal compounds, for example inorganic metal compounds, contained in the additive (1). The metal seeds formed by the activation are then metallized to create the electrically conductive structure on the substrate material. Because the additive (1) has a preferably full-surface coating before the additive is introduced into the substrate material, such that the additive (1) is reduced and the coating is oxidized by the laser activation, the reaction partners necessary for the required chemical reaction with the additive (1) are provided by the coating. Because of the thereby significantly reduced interaction with the substrate material, the limitation to certain plastics or plastic groups also is lifted.

### CROSS-REFERENCE TO RELATED APPLICATIONS

This application is a U.S. national stage application under 35 U.S.C. §371 of International Application No. PCT/DE2013/100412 filed on Dec. 6, 2013, and claims benefit to German Patent Application No. DE 10 2013 100 016.9 filed on Jan. 2, 2013. The international application was published in German on Jul. 10, 2014, as WO 2014/106503 A2 under PCT Article 21(2).

### FIELD

The invention relates to a method for producing an electrically conductive structure.

### BACKGROUND

Solid, molded interconnect devices are known in practice under the name MID and are already in use in many cases. MID technology combines electrical and mechanical functions in one component. In this case, the conductive structure is integrated in the housing and thus substitutes the conventional circuit board in order to reduce weight, installation space and assembly costs.

Special importance is assigned in the process to Laser Direct Structuring (LDS). In the LDS process, substrate materials are injection molded as preformed parts in single component injection molding with specially additivated plastics granulate. The additives can be converted selectively into catalytically active seeds by means of a laser in a physical/chemical reaction, metal being deposited in a subsequent chemical metallizing bath in a targeted manner at the sites thus treated.

In addition to activation, the laser is also responsible for producing a microrough surface in order to ensure adequate adhesion of the metal layer on the plastics substrate.

Since the region that is exposed to laser radiation is controlled by computer software, circuit layouts can be adapted or modified in the LDS procedure in the shortest time and without modifying tools. These circumstances and the commercial availability of various LDS-capable plastics materials have ultimately led to the LDS procedure being the leading technology in the production of MIDs.

DE 101 32 092 A1 describes conducting track structures on an electrically non-conductive substrate material, which consist of metal seeds and a metal coat which is subsequently applied thereto, the metal seeds having come about by splitting, by means of electromagnetic radiation, electrically non-conductive inorganic metal compounds contained in an extremely highly dispersed manner in the substrate material.

DE 10 2004 021 747 A1 likewise describes such conducting track structures, the metal seeds having come about by splitting, by means of electromagnetic radiation, nanoscale metal compounds contained in an extremely highly dispersed manner in the substrate material. In order to retain the transparency of the substrate material, which is translucent and therefore allows the combination of conducting track structures and translucent substrate materials for optoelectronic use, nanoscale non-conductive metal compounds are used, the particles of which have nano dimensions with characteristic sizes of under 200 nm. As a result of this the transparency of the substrate material and the function of the non-conductive metal compound are retained.

Furthermore, in WO 2012/056385 A1 a method with an improved currentless plating performance of LDS materials is described.

Owing to technological limits, these days track widths of at least 150 μm can be produced reliably by means of LDS methods. In order to further advance the desired miniaturization of MIDs, it is absolutely necessary to force the limits back still further. For this purpose, great effort is being made on the one hand to increase the focus of the laser radiation and guide it more precisely over the surface of the molded part. On the other hand, the size of the additive is to be reduced in order to ensure a better sharpness of the edges of the laser structuring. It must, however, be considered in the process that this approach has its limits, since the tendency of the additive to agglomerate during the compounding or injection molding process generally increases with decreasing particle size.

Three aspects are of particular importance in this context:
1) The physical properties of the base polymer and the workpieces produced therefrom, such as impact resistance and break resistance, are affected by the quantity, size, form and type of the additive.
2) The type of additive substantially determines what wavelength the laser radiation to be used can have and how efficiently this is absorbed.
3) The chemical/physical conversion of the additive into catalytically active seeds is stimulated at different rates by different materials and can remain absent in some materials.

### SUMMARY

An aspect of the invention provides a method for producing an electrically conductive structure, on a non-conductive substrate material, the method comprising: irradiating, using a laser, the substrate material, which comprises an additive comprising a first region, comprising a metal compound, and a second region, thereby selectively activating the metal compound in the additive; forming catalytically active seeds in regions, which are laser activated; reducing an oxidation number of a metal in a different chemical composition in the second region, which is laser activated; and then, metallizing the regions comprising catalytically active seeds, thereby creating the electrically conductive structure on the non-conductive substrate material.

### BRIEF DESCRIPTION OF THE DRAWINGS

The present invention will be described in even greater detail below based on the exemplary figures. The invention is not limited to the exemplary embodiments. All features described and/or illustrated herein can be used alone or combined in different combinations in embodiments of the invention. The features and advantages of various embodiments of the present invention will become apparent by reading the following detailed description with reference to the attached drawings which illustrate the following:

FIG. 1 shows an additive with irregular distribution of a first and second region;

FIG. 2 shows an additive with a second region achieved as a coating on a first region forming a core; and

FIG. 3 shows an additive with a second region forming a core.

### DETAILED DESCRIPTION

An aspect of the invention provides a method for producing an electrically conductive structure, in particular a conducting track, on a non-conductive substrate material, which contains an additive having at least one metal compound, the substrate being partially exposed to laser radiation and the metal compounds contained in the additive being activated, as a result of which catalytically active seeds form in the regions, which are laser activated thus, and are then metallized in an electroless metallizing bath and as a result, the electrically conductive structure is produced on the non-conductive substrate material.

An aspect of the invention is to design an additive in a suitable manner such that the additive-coating hybrid has fewer negative effects on the physical properties of the base polymer and is converted more effectively into catalytically active seeds by laser irradiation than the additive alone would be.

According to an aspect of the invention, a method is therefore provided in which, in addition to a first region formed by the for example inorganic metal compounds, the additive contains at least a second region with different chemical composition and the oxidation number of the metal in the additive is reduced by the laser activation. A reactive micro environment is created for the additive in that the additive comprises a second region as a substance with different chemical composition and the chemical reaction with the substrate material is substantially reduced or avoided altogether. Since the process of converting the additive into catalytically active seeds can be performed more efficiently by such a procedure, the necessary dose of the additive and therefore the required proportion in the substrate material is reduced. The minimum amounts of the additive, which have been reduced according to the invention, thus directly lead to lower effects on the properties of the substrate material. Since the additive-coating hybrid provides all of the materials necessary for the required chemical/physical reaction, the limitation to certain plastics materials or plastics groups is simultaneously omitted. For example, a substrate material with a substantial material proportion of a PTFE is consequently suitable for performing the method according to the invention if the additive which is provided with the second region is mixed in. It is, of course, not ruled out according to the invention that substances are additionally mixed into the additive as a second region.

It has been shown that such a second region, for example in the form of a coating, can in some cases not only greatly inhibit the agglomeration, but also advantageously have an effect on the subsequent chemical metallization. Closer examinations have revealed that some coating substances promote the chemical/physical conversion of the additive into catalytically active seeds better than the plastics matrix of the substrate material that surrounds them.

A substantial advantage of the invention emerges especially in that the additive can be added to any given substrate materials and therefore, the desired laser activation is achieved reliably irrespective of the special properties of the substrate material. In particular, therefore, the auxiliary material which has been required until now to adapt to different properties of the substrate material can be omitted. Therefore, the additive can also be first added or mixed in during the molding process, and therefore the additive does not already have to be present in the substrate material before processing.

The second region, however, also fundamentally leads to greatly improved mechanical properties if it contains substantially organic compounds. As a result of this, substantially organic portions encounter one another respectively at the boundary between the second region and the substrate material. As a result of the second region there are much smaller interruptions in the structure of the plastics material as substrate material of the additive. In particular, existing particle edges can be levelled by a second region including the metal compound such that notch effects of the additive in the substrate material, which cannot be reliably excluded in prior art, can be reduced or even prevented.

The second region can preferably be applied to the additive as a coating over the whole surface in order to thus achieve separation of the additive relative to the substrate material. For this purpose, the thickness of the coating is selected such that it has sufficient adhesion to the additive and thus is not separated from the additive and the coating is not damaged in particular when mixing the additive provided with the coating into the substrate material. Most preferably, the coating is applied to the additive in a quantity corresponding to the stoichiometric ratio between at least one agent contained in the coating and the additive, such that the amount of material required for the reduction of the additive is available in the coating. As a result of this, an interaction or a chemical reaction of the additive with the substrate material is largely prevented. In practice, a coating thickness of between 5 nm and 2 μm is applied according to the invention.

The additive could be provided in an aqueous solution which is introduced into the substrate material in liquid form. Particularly promising on the other hand is an embodiment of the invention, in which the additive provided with the second region is produced in a form that can be scattered or trickled, in particular in powder form and mixed into the substrate material. As a result of this, the production process and also the system conditions for producing the mixture are simplified. In particular, the desired mixture can be monitored simply on the basis of the mass ratios.

Since an interaction of the additive with the substrate material is largely omitted according to the invention because reaction partners intended for the additive are contained in the second region, the limitation to certain plastics materials suitable for the chemical reaction is lifted in the selection of the substrate material. As a result, such substrate materials that are inert or unable to react are also suitable for carrying out the method.

Another embodiment of the invention which is likewise particularly promising is achieved in that an absorber is introduced into the second region and facilitates the conversion of the laser energy for laser activation of the metal compounds contained in the additive. As a result of this, the conversion of the energy introduced by means of the laser irradiation into the required activation energy, which is required to trigger the reaction between the reaction partners contained in the second region on the one hand and the additive particles on the other hand, is implemented in an optimum manner and thus the efficiency is increased. These substances acting as absorbers in the second region therefore also facilitate, in a particularly advantageous manner, the desired activation when the second region and additive are transparent for the wavelength of the laser irradiation. According to the invention therefore, those additives that cannot be activated by the selected laser per se can also be used, since the reaction can be achieved by appropriate reaction partners in the second region and the resulting interaction between the substances contained in the second region and the additive. As a result of this, therefore, the additive is largely independent of the selection of the laser. The absorber is adjusted to the wavelength of the laser for this purpose. For example, absorbers in the IR wavelength range are suitable for this purpose.

According to a further aspect of the present invention, the substrate material contains a semiconductor material, ceramics and/or glass as a substantial material proportion such that the method according to the invention for selective activation and subsequent metallization can also be carried out in connection with such substrate materials that cannot have a reducing effect on the additive themselves. Furthermore, as a result of the chemical reaction of the additive with its second region, a modification of the chemical or physical properties of the substrate material is greatly reduced.

### Embodiment 1

One part copper (II) oxide powder (from the company Sigma-Aldrich) is dried in the vacuum drying oven at 150° C. and processed in a twin screw extruder (from the company Collin) with one part polybutylene terephthalate (from the company Lanxess) to make a homogenous granulate. The granulate is firstly milled in a fine impact mill (from the company Hosokawa/Alpine) to a particle size of 0.5 mm and then milled in a planetary ball mill (Pulverisette 7 Premium Line/1 mm zirconium oxide balls/zirconium oxide grinding bowl, from the company Fritsch) to a final fineness of about 1 μm. The thus obtained copper (II) oxide polybutylene terephthalate hybrid is then made into a compound with ten percent by mass polypropylene (from the company Ensinger) and injection molded to make workpieces. These thus obtained workpieces can be selectively activated by laser for electroless metallization. In comparison to sample pieces, which only contain unmodified copper (II) oxide, the thus obtained polypropylene workpieces exhibit performance that is increased many times over with respect to metallization.

### Embodiment 2

Two parts copper (I) oxide are mixed into one part polyester resin (from the company Presto) and cast into thin plates. After the complete hardening of the plates these are firstly mechanically crushed in a preliminary process. Then the granulate is milled to a particle size of 0.5 mm in a fine impact mill (from the company Hosokawa/Alpine) and then milled in a planetary ball mill (Pulverisette 7 Premium Line/1 mm zirconium oxide balls/zirconium oxide grinding bowl, from the company Fritsch) to a final fineness of about 1 μm. The thus obtained duroplastics copper (I) oxide polyester hybrid is then made into a compound with eight percent by mass polyethylene (from the company LyondellBasell) and injection molded to make workpieces. The thus obtained workpieces can be selectively activated by laser for electroless metallization. In comparison to sample pieces, which only contain unmodified copper (I) oxide, the thus obtained polyethylene workpieces exhibit performance that is increased many times over with respect to metallization.

### Embodiment 3

Two parts ferrous (III) oxide are dried at 130° C. and processed to form a homogenous granulate in a twin screw extruder (from the company Collin) with one part liquid crystal polymer (from the company Ticona). The granulate is firstly milled in a fine impact mill (from the company Hosokawa/Alpine) to a particle size of 0.5 mm and then milled in a planetary ball mill (Pulverisette 7 Premium Line/1 mm zirconium oxide balls/zirconium oxide grinding bowl, from the company Fritsch) to a final fineness of about 1 μm. The thus modified ferrous (III) oxide is then processed with twelve percent by mass into a polyurethane (from the company SLM Solutions) and molded in a vacuum casting process into workpieces. These thus obtained workpieces can be selectively activated by laser for electroless metallization. In comparison to sample pieces, which only contain unmodified ferrous (III) oxide, the thus obtained polyurethane workpieces exhibit performance that is increased many times over with respect to metallization.

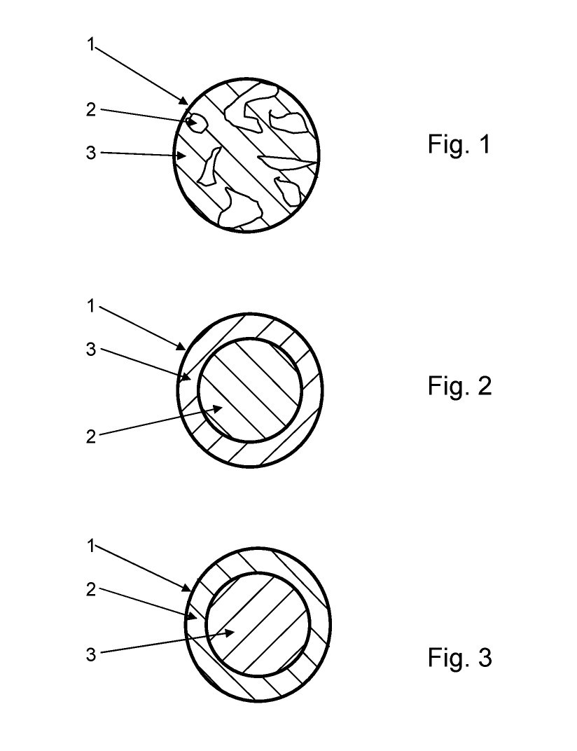

The additive according to the invention for producing an electrically conductive structure on a substrate (not shown) is described in more detail hereinafter with reference to FIGS. 1 to 3. For this purpose, the additive 1 contains at least one metal compound forming a first region 2. This metal compound is preferably selectively activated by irradiation by means of a laser, as a result of which catalytically active seeds form in the region, which is laser activated thus, and are then metallized. In addition to the metal compound, the additive 1 also contains a second region 3 with one or various substances of chemical composition differing from the metal compound such that the oxidation number of the metal in the additive 1 is reduced by the laser activation. Since the additive 1 has a further substance which is adapted to the metal compound and has a different chemical composition, a reactive micro environment is created therefor and the chemical reaction with the substrate is substantially reduced or prevented altogether. The process of converting the metal compound into catalytically active seeds is therefore much more efficient irrespective of the substrate material, the required proportion in the substrate being reduced at the same time. Since the additive 1 provides all of the materials needed for the required chemical/physical reaction, the limitation to certain plastics or plastics groups is also lifted at the same time.

In the variant of the additive 1 shown in FIG. 1, an irregular mixture of the two regions 2, 3 is used for this purpose and in particular facilitates simple production, for example even during the molding process.

In contrast, a separation of the additive 1 relative to the substrate material can be achieved by the variant shown in FIG. 2 where the second region 3 is applied to whole surface of the metal compound as a coating in order to thus prevent an undesirable chemical reaction of the substrate material with the metal compound.

Furthermore, in the variant shown in FIG. 3, the metal compound can fully enclose the second region 3 if, for example, a reaction of the additive 1 with the substrate material is required in certain applications and the second region 3 is simply intended to assist the chemical reaction.

While the invention has been illustrated and described in detail in the drawings and foregoing description, such illustration and description are to be considered illustrative or exemplary and not restrictive. It will be understood that changes and modifications may be made by those of ordinary skill within the scope of the following claims. In particular, the present invention covers further embodiments with any combination of features from different embodiments described above and below. Additionally, statements made herein characterizing the invention refer to an embodiment of the invention and not necessarily all embodiments.

The terms used in the claims should be construed to have the broadest reasonable interpretation consistent with the foregoing description. For example, the use of the article “a” or “the” in introducing an element should not be interpreted as being exclusive of a plurality of elements. Likewise, the recitation of “or” should be interpreted as being inclusive, such that the recitation of “A or B” is not exclusive of “A and B,” unless it is clear from the context or the foregoing description that only one of A and B is intended. Further, the recitation of “at least one of A, B, and C” should be interpreted as one or more of a group of elements consisting of A, B, and C, and should not be interpreted as requiring at least one of each of the listed elements A, B, and C, regardless of whether A, B, and C are related as categories or otherwise. Moreover, the recitation of “A, B, and/or C” or “at least one of A, B, or C” should be interpreted as including any singular entity from the listed elements, e.g., A, any subset from the listed elements, e.g., A and B, or the entire list of elements A, B, and C.

1. A method for producing an electrically conductive structure on a non-conductive substrate material, the method comprising:
irradiating, using a laser, the substrate material, which comprises an additive comprising a first region, comprising a metal compound, and a second region, thereby selectively activating the metal compound in the additive;
forming catalytically active seeds in regions, which are laser activated;
reducing an oxidation number of a metal in a different chemical composition in the second region, which is laser activated; and
then, metallizing the regions comprising catalytically active seeds, thereby creating the electrically conductive structure on the non-conductive substrate material.

2. The method of claim 1, wherein the metal compound forms core of the additive, and
wherein the core is surrounded at least in portions by the second region.

3. The method of claim 1, wherein the metal compound is penetrated at least in portions by the second region.

4. The method of claim 1, wherein the metal compound surrounds the second region at least in portions.

5. The method of claim 1, wherein at least one dimension of the additive is smaller than 5 μm.

6. The method of claim 1, wherein the second region substantially comprises an organic compound.

7. The method of claim 1, wherein the second region substantially comprises a reductive metal compound.

8. The method of claim 2, wherein the second region is applied to a thickness of between 5 nm and 2 μm.

9. The method of claim 1, further comprising:
introducing an absorber into the second region, thereby facilitating conversion of laser energy for the laser activation of the metal compound.

10. The method of claim 1, wherein the metal compound comprises a metal oxide.

11. An additive, adapted for producing an electrically conductive structure on a non-conductive substrate, the additive comprising:
a metal compound as a first region;
a second region at least partially coating the first region,
wherein the second region has a different chemical composition from the first region, and
wherein an oxidation number of a metal in the additive can be reduced by laser activation.

12. A substrate material comprising:
the additive of claim 11; and
a polymer, semiconductor material, ceramic, wood, glass, or mixture of two or more of any of these as a substantial proportion of the substrate material.

13. The method of claim 1, wherein the conductive structure is a conducting track.

14. The method of claim 1, wherein the metal compound forms core of the additive, and
wherein the core is surrounded by the second region, in the form of a coating.

15. The method of claim 1, wherein the metal compound surrounds the second region.

16. The method of claim 1, wherein the second region consists essentially of at least one organic compound.

17. The method of claim 1, wherein the second region consists essentially of at least one reductive metal compound.
